(19) United States
(12) Patent Application Publication
(10) Pub. No.: US 2026/0322046 A1
(43) Pub. Date: Oct. 15, 2026

(54) PLUG-IN CONNECTOR SYSTEM

(71) Applicant: HARTING Electric Stiftung & Co. KG, Espelkamp (DE)

(72) Inventors: Markus FRIESEN, Espelkamp (DE); Christian CORDING, Wagenfeld (DE); Henry KORNELSEN, Minden (DE)

(21) Appl. No.: 19/104,185

(22) PCT Filed: Sep. 6, 2023
(86) PCT No.: PCT/DE2023/100650

§ 371 Date: Feb. 14, 2025

(30) Foreign Application Priority Data
Sep. 23, 2022 (DE) 10 2022 124 490.3

(51) Int. Cl. H01R 13/719; G06K 19/07; H01Q 1/22; H01R 13/6581; H01R 13/74

(52) U.S. Cl. CPC H01R 13/719; G06K 19/0723; H01Q 1/2208; H01R 13/6581; H01R 13/74

(57) ABSTRACT

A high-current-capable plug-in connector system has an add-on plug-in connector and a mating plug connector, with an RFID system, a transponder antenna arranged in or on the socket housing of the mating plug connector and also to fit a reader antenna as an encircling coil around the contact carrier of the add-on plug-in connector in or on the add-on plug-in connector.

The invention is based on a plug-in connector system.

### BACKGROUND OF THE INVENTION

Such plug-in connector systems usually have at least one add-on plug-in connector and one mating plug-in connector, as well as an RFID (“Radio Frequency Identification”) system, and may be used, inter alia, for identification of the mating plug-in connector by the add-on plug-in connector. This also makes it possible for the add-on plug-in connector, or an electrical device to which the add-on plug-in connector is attached, to monitor a means connected to the mating plug-in connector on the cable connection side. In particular, this enables a so-called “access control” to be effected, i.e. only authorized means may be operated with their mating plug-in connectors on add-on plug-in connectors intended for this purpose—and thus on their respective electrical devices. In particular, these plug-in connector systems may have high-current capability. The term “high-current capability” in this case means that the add-on plug-in connectors and mating plug-in connectors are designed for currents of more than 16 A (“amperes”), e.g. at least 24 A, in particular at least 32 A, preferably at least 48 A and above, e.g. for 56 A and above.

Intelligent sockets, also known as “smart sockets”, are known in the prior art, for example from the publication DE 10 2015 009 361 A1. These intelligent sockets are usually used between an electrical supply network, preferably a 220V AC network, and an electrical device of which the add-on plug-in connector is connected to the socket cup of the adapter.

This publication also discloses in this regard that the plug of the electrical device to be plugged into the socket insert is equipped with a radio tag, saved on which there are data relating to the device type of the electrical device to be connected to the intelligent socket. The radio tag may be an RFID transponder or NFC transponder.

It is furthermore disclosed that the intelligent socket is provided with a reader that enables communication between the radio tag and the reader when the plug is inserted, in such a way that a signal, containing modeled data relating to the device type of the electrical device plugged into the socket, is contactlessly sensed by the reader from the radio tag of the electrical device and transmitted by the reader to a remote data processing device.

A disadvantage of the known prior art is that there is no sufficiently uncomplicated solution for integrating such RFID systems, in particular NFC systems, into plug-in connector systems that already exist on the market. In particular in the field of industrial plug-in connectors having high-current capability, there is a significant need for a simple and inexpensive solution for integrating such an RFID system into the respective add-on plug-in connector. The term “high-current capability” means in this case that the add-on plug-in connectors are designed for currents of more than 16 A (“amperes”), e.g. at least 24 A, in particular at least 32 A, preferably at least 48 A and above, e.g. for 56 A and above.

The German Patent and Trade Mark Office has searched the following prior art in the priority application relating to the present application: DE 196 15 221 A1, DE 10 2005 022 281 A1, DE 10 2005 044 918 A1, DE 10 2006 030 077 A1, DE 10 2020 111 610 A1, US 2006/0 049 942 A1, US 2006/0 072 271 A1 and WO 2014/037 586 A2.

### SUMMARY OF THE INVENTION

The object of the invention is to provide a structural form for a plug-in connector system, having an add-on plug-in connector and a mating plug-in connector, that has an RFID (“Radio Frequency Identification”) system integrated into it in an uncomplicated manner. The structural form for the RFID system is intended to ensure reliable data transmission between an RFID reader of the add-on plug-in connector and an RFID transponder of the mating plug-in connector. In particular, the structural form is intended to prevent crosstalk between the aforementioned RFID system and further RFID systems of adjacent and structurally comparable plug-in connector systems as effectively as possible.

The plug-in connector system has an add-on plug-in connector and a mating plug-in connector. The add-on plug-in connector has an add-on housing by which it may be attached to a wall opening of a housing wall of a device housing of an electrical device. The add-on plug-in connector additionally has a contact carrier and at least one plug-in contact that is accommodated in the contact carrier and can be connected in an electrically conductive manner, on the connection side, to an electrical conductor of a device cable of the electrical device. The mating plug-in connector has a sleeve housing to which a further electrical cable can be fixed on the connection side. The mating plug-in connector has a mating contact carrier, and at least one mating contact accommodated therein for connecting in an electrically conductive manner, on the plug-in side, to the said plug-in contact of the add-on plug-in connector. The mating contact can be connected in an electrically conductive manner, on the connection side, to a further electrical conductor of the further electrical cable.

The plug-in connector system has an RFID (“Radio Frequency Identification”) system, in particular an NFC (“Near Field Communication”) system. The RFID system has an RFID transponder, which is preferably an NFC (“Near Field Communication”) transponder. The RFID transponder has a transponder microchip and a transponder antenna that is connected thereto in an electrically conductive manner. Furthermore, the RFID system has an RFID reader, which is preferably an NFC reader, and which has a reader microchip and a reader antenna that is connected to the reader microchip in an electrically conductive manner.

The transponder microchip is attached in or on the mating plug-in connector, in particular in or on the sleeve housing or the contact carrier of the mating plug-in connector. Furthermore, the transponder antenna, which is connected to the transponder microchip in an electrically conductive manner, is attached in or on the mating plug-in connector, in particular in or on the add-on housing of the mating plug-in connector.

Furthermore, the reader antenna, which is connected in an electrically conductive manner to the RFID reader, is attached in the form of a circumferential coil in or on the add-on plug-in connector, in particular in or on the add-on housing of the add-on plug-in connector.

It is particularly advantageous that such an RFID system can be integrated into an already existing plug-in connector system having high-current capability. The term “high-current-capability” means that the plug-in connector system is designed to carry currents of more than 16 A (“amperes”), e.g. at least 24 A, in particular at least 32 A, preferably at least 48 A and above, e.g. 56 A and above.

A particular advantage of the invention is that comparatively small add-on housings, having diameters of less than 5 cm, preferably less than 4 cm, in particular even less than 3.5 cm, for example 3 cm and even less, may also be used.

Moreover, it is particularly advantageous that existing plug-in connector systems may be retrofitted with such an RFID system, for example by realizing the reader antenna as an inlay, e.g. in the form of a flexible printed circuit board to which the coil is attached in the form of a strip conductor.

Advantageously, it is possible to introduce the additional RFID/NFC functionality into various already existing plug-in connector systems by adapting the dimensions of the reader antenna to the dimensions of the respective add-on plug-in connector.

It is particularly advantageous in this case that the positive properties of the respective plug-in connector system are retained, e.g. its sealing concept, and thus its tightness against environmental influences such as dust, dirt and moisture.

In a preferred design, the reader antenna has a coil axis that is orientated in the plug-in direction.

In a further preferred design, both the transponder antenna and the reader antenna are each realized as a magnetic field antenna.

In a further preferred embodiment, the transponder antenna is oriented parallel to the coil axis of the reader antenna in the plug-in direction and is arranged, in particular, as an extension of the coil edge.

In a preferred design, the add-on housing and the contact carrier are realized in one piece. This is advantageous because it simplifies production. In addition, this makes the arrangement of the RFID reader and its reader antenna particularly flexible.

In another advantageous design, the contact carrier and the add-on housing are separate parts. This has the advantage that the plug-in connector housing may be composed of a magnetically shielding material, thereby preventing crosstalk to RFID systems of adjacent plug-in connector systems of comparable structural form all the more effectively. At the same time, the contact carrier may be composed of an electrically insulating material.

In an advantageous design, the reader antenna, realized as a circumferential coil, may be fastened to the inside or outside of the add-on housing in such a way that the coil follows the contour of the add-on housing, around the contact carrier, in a uniformly circumferential manner.

In an advantageous design, the reader antenna may be molded into the contact carrier/add-on housing and/or overmoulded during the manufacturing process. In particular, the coil may be molded onto the circumferential seal or overmoulded with the sealing material, i.e. arranged in the seal.

In a further preferred design, the add-on plug-in connector, in particular the add-on housing or the contact carrier, has a circumferential groove into which a reader antenna, which, as already mentioned, is realized in the form of a coil, may be placed.

In a preferred design, the add-on housing and/or the contact carrier is realized as a 3D-MID component. The reader antenna is then inserted into, or attached, in the form of MID strip conductors, to the add-on housing or the contact carrier.

It is particularly advantageous in this case that the reader antenna and the transponder antenna are protected by the add-on housing from external environmental influences.

In an alternative design, the reader antenna may be arranged outside the add-on housing.

In a further design, the RFID transponder, with its transponder antenna, may be fastened to the outside of the mating plug-in connector.

In a preferred design, the reader microchip is arranged, in particular fastened, in or on the add-on plug-in connector, in particular in or on the add-on housing or the contact carrier of the add-on plug-in connector.

### BRIEF DESCRIPTION OF THE DRAWINGS

An exemplary embodiment of the invention is represented in the drawings and explained in more detail in the following. In the drawings:

FIG. 1 shows a schematic representation of a plug-in connector system with an RFID system integrated therein;

FIG. 2 shows a 3D representation of an add-on housing of the plug-in connector system.

### DETAILED DESCRIPTION OF THE INVENTION

The figures include some simplified schematic representations. In some cases, identical reference designations are used for elements that are similar but possibly not identical. Different views of the same elements may be scaled differently. Indications relating to direction such as, for example, “left”, “right”, “up” and “down” are to be understood with reference to the respective figure and may vary in the individual representations with respect to the object represented.

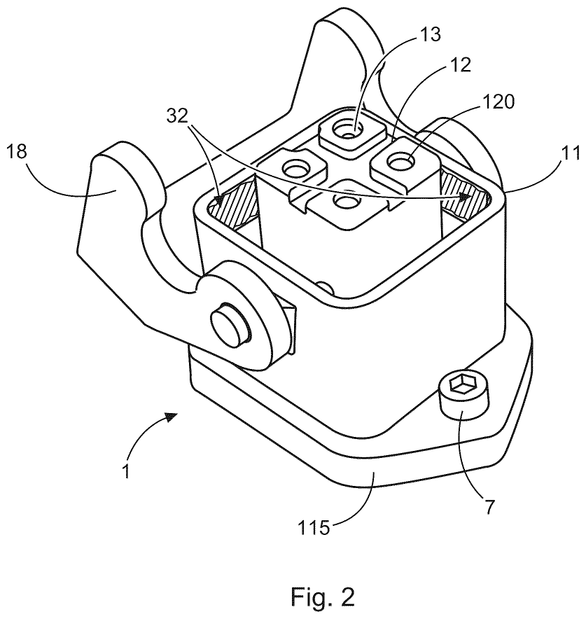

FIG. 1 shows a plug-in connector system having an RFID (“Radio Frequency Identification”) system, namely an NFC (“Near Field Communication”) system, integrated therein.

The plug-in connector system has an add-on plug-in connector 1 and a mating plug-in connector 2. The add-on plug-in connector 1 has an add-on housing 11. The add-on housing 11 has an add-on flange 115 for fastening to a housing wall, not shown, of a device housing of an electrical device. Furthermore, the add-on plug-in connector 1 has a contact carrier 12 arranged in the add-on housing, as well as a plurality of plug-in contacts 13, accommodated in the contact carrier 12, one of which is visible and denoted in the following figure.

Furthermore, a plurality of electrical guides 53 are shown at the bottom of FIG. 1. These electrical conductors 53 belong to a device cable of the electrical device. Typically, each plug-in contact 13 is connected in an electrically conductive manner to one of the electrical conductors 53.

The mating plug-in connector 2 has a sleeve housing 21 into which a further electrical cable (not shown) can be inserted on the connection side (coming from above in the drawing). This further electrical cable can be fixed to the sleeve housing 21, e.g. by means of a cable gland.

The mating plug-in connector 2 additionally has a mating contact carrier, not shown for reasons of clarity, that is arranged in the sleeve housing 21, and at least one mating contact accommodated therein for electrically conductive, i.e. plug-in, connection, on the plug-in side, to the plug-in contact 13 of the add-on plug-in connector 1. The mating contact in this case can be connected in an electrically conductive manner, on the connection side, to a further electrical conductor of the further electrical cable.

The plug-in connector system has an RFID “Radio Frequency Identification” system specialized for near field communication, namely an NFC (“Near Field Communication”) system, it being clear to a person skilled in the art that everything stated here about the NFC system also applies analogously in general to the RFID system.

The NFC system has an NFC transponder and an NFC reader. The NFC transponder has a transponder microchip, not shown, and a transponder antenna 32 connected to it in an electrically conductive manner. The NFC reader has at least one reader microchip, not shown, and a reader antenna 31 connected to it in an electrically conductive manner.

The transponder microchip and the transponder antenna 32 are each attached in or on the mating plug-in connector 2.

The reader antenna 31, shown here symbolically in cross-section, is attached in the form of a circumferential coil to the add-on housing 1. It can already be seen here, but even more clearly in the following representation, that the reader antenna 31, realized as a circumferential coil, is fastened to the add-on housing 11 from the inside and thus follows a circumferential contour of the add-on housing 11, around the contact carrier 12. Here, the reader antenna 31 is routed via an antenna connection lead 33, which in the drawing is routed downward, into the electrical device housing, in which, for example, the NFC reader may be arranged. Alternatively, the NFC reader may also be attached in or on the add-on plug-in connector, which facilitates installation.

The transponder antenna 32 is arranged orthogonally with respect to the reader antenna 31, and is thus located in a rather unusual position.

In this case, however, the transmission of data between the NFC transponder and the NFC reader with this rather unusual arrangement is very good, because its transponder antenna 32 is located, at least in a good approximation, in an extension of the edge of the reader antenna 31 realized as a coil. At this site, the magnetic field 34 is almost optimal, as here the magnetic field lines 34 are at right angles to the transponder antenna 32.

For this purpose, the transponder antenna 32 is oriented parallel to the coil axis of the reader antenna 31, and thus in the plug-in direction, and is additionally attached to the sleeve housing 21 in an extension of the coil edge, namely from the inside.

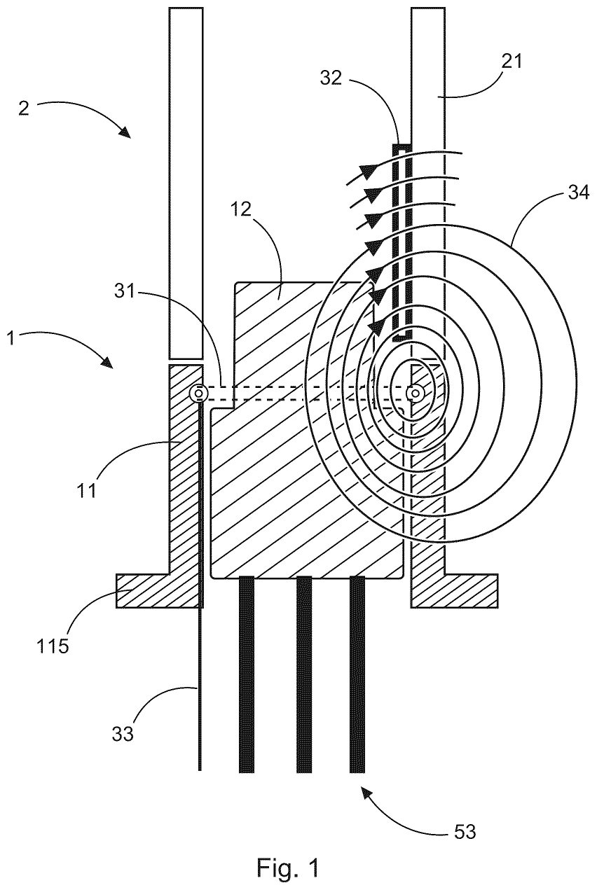

In FIG. 2, the arrangement of the reader antenna 31 in the add-on housing 11 can be seen again particularly well in a 3D representation. In this case, the reader antenna 31 is realized as an inlay in which the coil is formed from strip conductors of a flexible printed circuit board. This inlay is glued into the add-on housing 11 from the inside in such a way that the reader antenna 31, which is thus realized as a circumferential coil, follows a circumferential contour of the add-on housing 11, around the contact carrier 12.

Also shown is a plug-in contact 13, which is located in a contact receiver 120 of the contact carrier. The contact receiver 120 is a through-opening of the contact carrier 12, such that the contact 13 can be connected in an electrically conductive manner to the electrical conductor 53 of the device cable on the connection side (from below in the drawing), i.e. can be connected to it.

Also shown is a screw 7, which passes through a screw hole in the add-on flange 115. On the opposite side, the add-on flange 15 has another screw 7, which passes through a further screw hole, but cannot be seen because it is concealed by the connector housing. The add-on housing 11 can thus be screw-connected to the said housing wall of the device housing.

### LIST OF REFERENCE DESIGNATIONS

1 add-on plug-in connector
11 add-on housing
115 add-on flange
12 contact carrier
120 contact receivers/through-openings
13 plug-in contact
18 locking clip
2 mating plug-in connector
21 sleeve housing
31 reader antenna
32 transponder antenna
33 antenna connection lead
34 magnetic field/magnetic field lines
53 electrical conductor of the device cable
7 screw

1. A plug-in connector system, having an add-on plug-in connector and a mating plug-in connector, wherein the add-on plug-in connector has an add-on housing configured for fastening to a housing wall of a device housing of an electrical device, and furthermore has a contact carrier and at least one plug-in contact that is accommodated in the contact carrier and configured to be connected in an electrically conductive manner, on the connection side, to an electrical conductor of a device cable of the electrical device, and wherein the mating plug-in connector has a sleeve housing to which a further electrical cable can be fixed on the connection side, and wherein the mating plug-in connector has a mating contact carrier, and at least one mating contact accommodated therein configured for connecting in an electrically conductive manner, on the plug-in side, to the said plug-in contact of the add-on plug-in connector, wherein the mating contact is configured to be connected in an electrically conductive manner, on the connection side, to a further electrical conductor of the further electrical cable;
wherein
the plug-in connector system furthermore has an RFID (“Radio Frequency Identification”) system, wherein the RFID system has an RFID transponder, which has a transponder microchip and a transponder antenna that is connected thereto in an electrically conductive manner, and wherein the RFID system furthermore has an RFID reader, which has at least one reader microchip and a reader antenna that is connected thereto in an electrically conductive manner, wherein
the transponder microchip and the transponder antenna are each attached in or on the sleeve housing, and wherein furthermore
the reader antenna is attached in the form of a circumferential coil in or on the add-on plug connector.

2. The plug-in connector system as claimed in claim 1, wherein the reader antenna is arranged circumferentially around the contact carrier.

3. The plug-in connector system as claimed in claim 1, wherein the reader antenna is configured as a circumferential coil, is fastened to the inside or outside of the add-on housing and thus follows a circumferential contour of the add-on housing, around the contact carrier.

4. The plug-in connector system as claimed in claim 1, wherein both the transponder antenna and the reader antenna are each in a form of a magnetic field antenna.

5. The plug-in connector system as claimed in claim 1, wherein the reader antenna has a coil axis that is oriented in the plug-in direction.

6. The plug-in connector system as claimed in claim 5, wherein the transponder antenna is oriented parallel to the coil axis of the reader antenna in the plug-in direction.

7. The plug-in connector system as claimed in claim 1, wherein the add-on housing and the contact carrier are formed together in one piece.

8. The plug-in connector system as claimed in claim 1, wherein the contact carrier and the add-on housing are separate parts, wherein the add-on housing is comprised of a magnetically shielding material, and the contact carrier is comprised of an electrically insulating material.

9. The plug-in connector system as claimed in claim 1, wherein the reader antenna is molded into or onto the add-on housing.

10. The plug-in connector system as claimed in claim 1, wherein the reader antenna has a flexible printed circuit board to which the coil is attached in the form of a strip conductor.

11. The plug-in connector system as claimed in claim 1, wherein the add-on housing or the contact carrier has a circumferential groove in which the reader antenna is arranged.

12. The plug-in connector system as claimed in claim 1, wherein, the add-on housing and/or the contact carrier is realized as a 3D-MID (“Molded Interconnect Device”) component.

13. The plug-in connector system as claimed in claim 1, wherein, when the system is plugged-in, the transponder antenna is oriented orthogonally with respect to the reader antenna.

14. The plug-in connector system as claimed in claim 1, wherein the reader microchip is arranged in or on the add-on plug-in connector, in particular in or on the add-on housing or the contact carrier of the add-on plug-in connector.

15. The plug-in connector system as claimed in claim 1, wherein the RFID system is an NFC (“Near Field Communication”) system, i.e. the RFID transponder is an NFC transponder, and the RFID reader is an NFC reader.

16. The plug-in connector system as claimed in claim 2, wherein the reader antenna is configured as a circumferential coil, is fastened to the inside or outside of the add-on housing and thus follows a circumferential contour of the add-on housing, around the contact carrier.

17. The plug-in connector system as claimed in claim 2, wherein both the transponder antenna and the reader antenna are each in a form of a magnetic field antenna.

18. The plug-in connector system as claimed in claim 2, wherein the reader antenna has a coil axis that is oriented in the plug-in direction.

19. The plug-in connector system as claimed in claim 18, wherein the transponder antenna is oriented parallel to the coil axis of the reader antenna in the plug-in direction.

20. The plug-in connector system as claimed in claim 2, wherein the add-on housing and the contact carrier are formed together in one piece.
